(19) United States
(12) Patent Application Publication
(10) Pub. No.: US 2012/0282053 A1
(43) Pub. Date: Nov. 8, 2012

(54) DRILLING DEVICE

(75) Inventors: Nebil Antar, Augsburg (DE); Jan-Christoph Arent, Donauwoerth (DE); Matthias Heckl, Donauwoerth (DE); Christian Höenle, Wemding (DE)

(73) Assignee: AIRBUS SAS, Blagnac (FR)

(21) Appl. No.: 13/503,423

(22) PCT Filed: Oct. 22, 2010
(86) PCT No.: PCT/EP2010/006485

§ 371 Date: Jul. 20, 2012

(30) Foreign Application Priority Data
Oct. 23, 2009 (DE) 10 2009 050 476.1

(51) Int. Cl. B23B 39/16; B23B 49/00; B23B 41/00

(52) U.S. Cl. 408/16; 408/72 R; 408/31

(57) ABSTRACT

Disclosed is a drilling device with a reception device for purposes of receiving a component, in particular a freight door, with at least one drilling head for purposes of introducing at least one bore into the component, wherein the reception device allows stress-free mounting of the component in its installed orientation.

### TECHNICAL FIELD

The invention concerns a drilling device for the manufacture of a component with bores that are aligned with one another.

### BACKGROUND OF RELATED ART

In aircraft construction freight doors are often manufactured in a componental form of construction, and have two skin fields, between which is arranged a stiffening structure made up of a multiplicity of ribs and stringers. They are often mounted in the region of an upper edge such that they can be pivoted about a hinge axis. The locking of the freight door is undertaken by means of a multiplicity of hooks, which are arranged in the region of a lower edge of the freight door. The adjustment of the hooks as well as their locking action takes place by means of a drive shaft and a security shaft extending parallel to the drive shaft; each of the hooks is guided into a rib fork.

A method of known art for the manufacture of such a freight door 2 is shown in FIGS. 1 to 3. In accordance with FIG. 1 the ribs 4 are firstly arranged parallel to one another, and the rib bores 6 including bushings 8, which are already present, are oriented in alignment with one another. Subsequently, as shown in FIG. 2, the stiffening structure 12 is formed on the outer skin field 14 and riveted with the latter. As a result of the riveting of the individual parts 4, 8, stresses are introduced into the freight door 2 as soon as this freight door 2 is removed from the riveting device. The freight door 2 warps such that the rib bores 6 and bushings 8 are no longer oriented in alignment with one another, but instead are displaced relative to one another, which, as shown in FIG. 3, makes the insertion of a drive shaft 10 into the bushings 8 difficult.

### SUMMARY

The object of the present invention is to create a drilling device for purposes of introducing bores into a component that are aligned with one another, which removes the above-cited disadvantages, and allows the manufacture of precision bores.

This object is achieved by means of a drilling device with the features of Claim 1.

An inventive drilling device, in particular a CNC-controlled shaft-drilling and spindle facility, has a reception device for purposes of receiving a component, in particular a freight door of an aerospace vehicle, with at least one drilling head for purposes of introducing at least one bore into the component. In accordance with the invention the reception device allows the component to be mounted in the drilling device in a stress-free manner in its installed orientation, or in a position that is close to its installed orientation. By this means the introduction of undesirable stresses into the component during the drilling process is avoided. This is particularly advantageous if a multiplicity of bores are to be introduced into the component in precise alignment, which serve, for example, to receive shafts or axes. Deformations or stresses in the component as a result of its weight are inventively taken into account during the drilling process.

In one example of embodiment the reception device defines a pivot axis for purposes of pivoting the component. This preferably runs underneath a centre of gravity of the received component, so that a pivotal movement of the component about the pivot axis can be automatically introduced by means of its weight. The component is mounted in a quasi-vertical position in the reception device.

In one example of embodiment a multiplicity of pairs of bores are introduced into fork-shaped component sections. For purposes of introducing such pairs of bores the drilling device can have a drilling head, which has diametrically arranged clamping elements, in each case for purposes of clamping a cutting tool. For purposes of using two identical cutting tools it is advantageous if the drilling head is fitted with a direction of rotation reversal unit.

The drilling device can have a second machining head, which can be activated independently of the first drilling head. By this means different machining tasks can be carried out on the component at the same time. The second machining head is preferably also a drilling head with a measurement device for purposes of determining a machining depth, so that it is possible, for example, to monitor a countersink depth in the surface region during the drilling process, and to halt the drilling process automatically when a design countersink depth has been achieved. The measurement device determines the countersink depth electronically and has a sensor system, which measures a current rise of a spindle drive receiving the cutting tool. However, the sensor system can also be embodied such that the machining depth can be determined by means of structure-borne sound.

The drilling device preferably has a fixture device for the positioning of parts to be attached to the component. By this means it is possible to align the parts that are to be attached, such as for example hinge elements, in their design position, i.e. corresponding to the design position of a hinge axis relative to the component, and by means of the necessary tolerance compensation measures, such as the use of adapters and washers, to attach the parts to the component in a stress-free manner.

Other advantageous examples of embodiment of the invention are the subject of further subsidiary claims.

### BRIEF DESCRIPTION OF THE DRAWINGS

In what follows preferred examples of embodiment of the invention are elucidated in more detail with the aid of schematic representations. Here:

FIGS. 1-3 show a method of known art for the manufacture of a freight door;

FIG. 4 shows a side view of an inventive freight door;

FIG. 5 shows a kinematic system for the activation of the hooks shown in FIG. 4;

FIGS. 6-9 show an inventive method for the manufacture of the freight door in FIG. 4; and

FIGS. 10-13 show an inventive activation of a drilling head.

### DETAILED DESCRIPTION

In the figures the same design elements have the same reference numbers, wherein where there is a plurality of the same design elements in one figure, only some of these design elements are provided with a reference number for reasons of clarity.

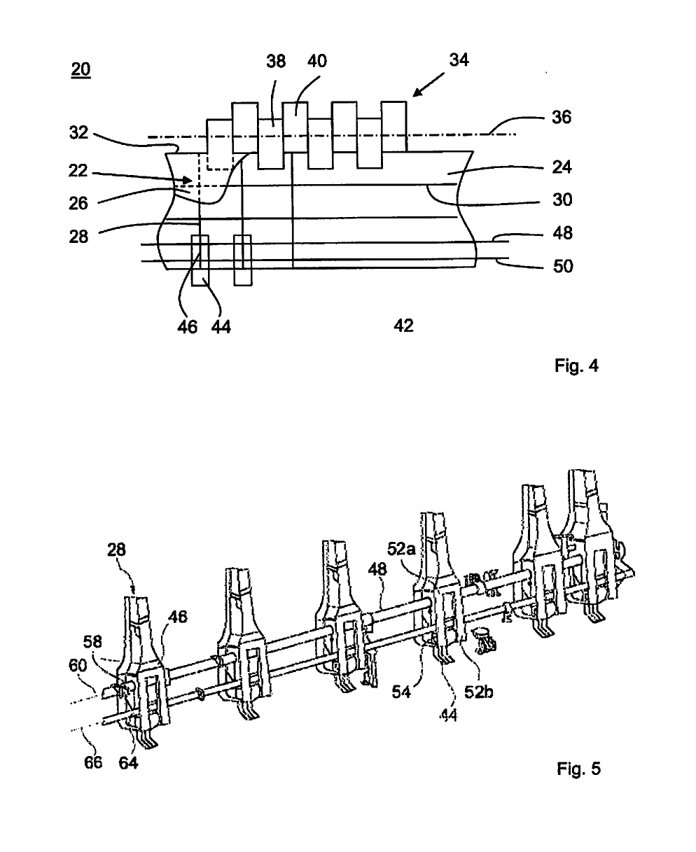

In accordance with the lateral sectional representation in FIG. 4 an inventive freight door 20 of an aircraft has a stiffening structure 22, which is arranged between two skin fields 24, 26. The stiffening structure 22 serves to provide stiffening of the skin fields 24, 26, i.e. of the freight door 20, and has a multiplicity of ribs 28 and a multiplicity of stringers 30. The ribs 28 and stringers 30 run in the circumferential and longitudinal directions of the freight door 20 respectively, and in each case are spaced apart from one another in a parallel manner. The freight door 20 is inserted into an opening of the aircraft's fuselage, and in the region of its upper edge 32 is mounted by means of a piano hinge 34 such that it can pivot about a hinge axis 36. The hinge 34 is formed from both door-side hinge elements 36 and also fuselage-side hinge elements 40; these are arranged side-by-side in an alternating manner in the longitudinal direction of the freight door 20.

Locking of the freight door 20 in the fuselage opening takes place in the region of a lower edge 42 by means of a multiplicity of hooks 44. The hooks 44 are arranged on a free end section 46 of each of the ribs 28, and can be adjusted by means of a drive shaft 48 extending parallel to the hinge axis 36, and can be secured in the locked position by means of a security shaft 50 extending parallel to the drive shaft 48.

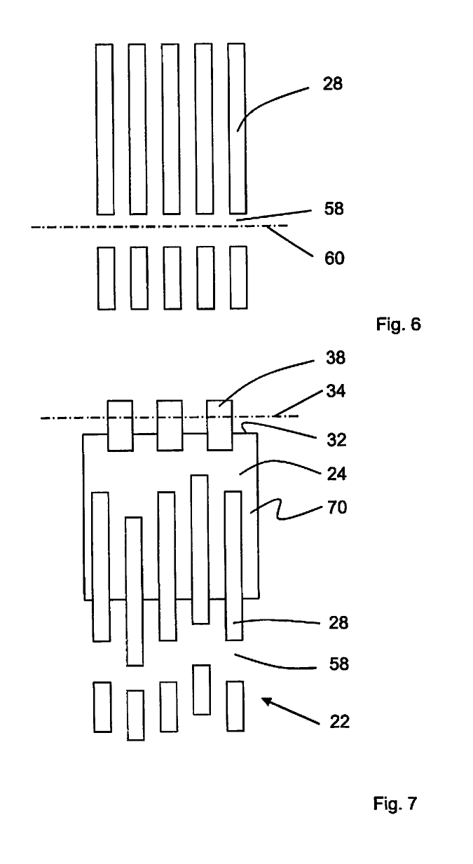

In accordance with the representation in FIG. 5 the free end sections 46 of the ribs 28 are embodied as rib forks, in each case with two arms 52a, 52b spaced apart from one another. The hooks 44 are mounted in each case between the arms 52 such that they can pivot about a pin (not numbered) inserted into a pair of hook bores 54. The drive shaft 48 is guided in a bore pattern made up of a multiplicity of bores 58 that are aligned with one another, with a common bore axis 60; these bores similarly extend through the arms 52a, 52b. For purposes of mounting the drive shaft 48 in the bores 60 appropriate bushings 62 (see FIG. 9) are provided. The security shaft 50 is guided in a bore pattern made up of a multiplicity of bores 64 that are aligned with one another with a common bore axis 66; these bores are arranged between the hook bores 54 and the bores for the drive shaft 48.

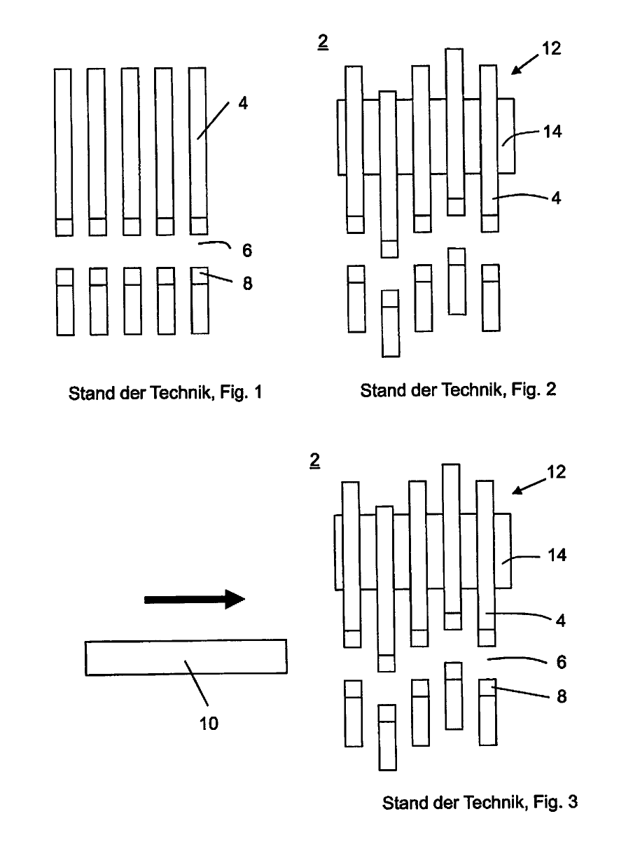

In what follows an inventive method for the manufacture of the freight door 20 in FIG. 1 is elucidated.

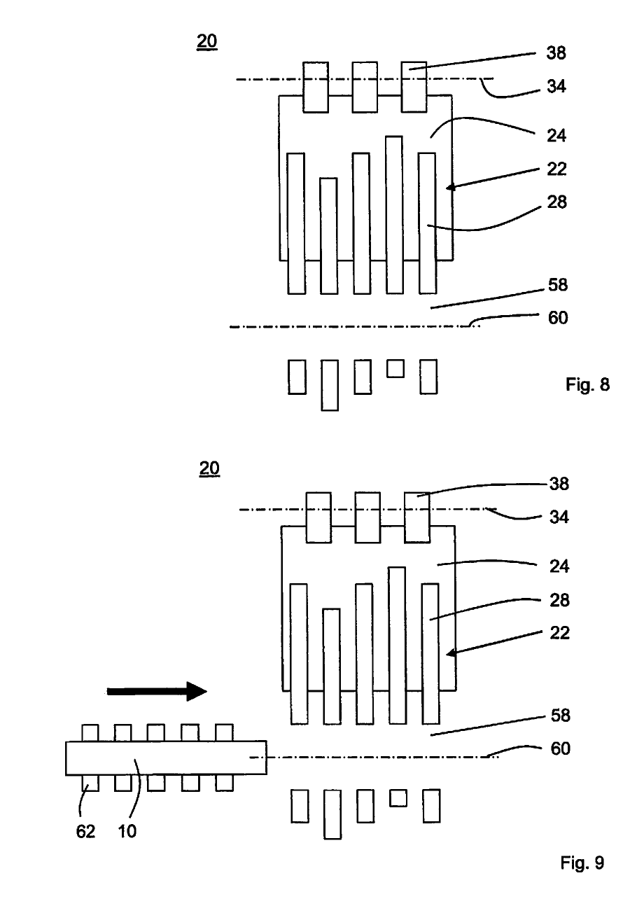

In accordance with FIG. 6 the ribs 28 are firstly spaced apart parallel to one another. Pilot bores are then drilled for the bores 58 for the drive shaft 48 and the bores 64 for the security shaft 50 (not shown in FIGS. 6 to 13, cf. FIG. 5). However, the pilot bores can also be fully developed, that is to say, in the case of small diameters pilot bores can be completely dispensed with. Similarly the hook bores 54 for reception of the hook pins in the ribs 28 are not shown in FIGS. 6 to 13. The hook bores 54 are preferably introduced before the ribs 28 are positioned side-by-side. The pilot drilling of each of the bores 58, 64 is undertaken by means of a continuous spindle, so that the bores 58, 64 are in each case arranged in alignment with one another, with common longitudinal axes 60, 66 respectively.

After the pilot-drilling of the bores 58, 64 the stiffening structure 22 is constructed on the outer skin field 24, and is connected with the latter. The skin field 24 is then lined up with the stiffening structure 22 and is translated into its design shape, i.e. into its final geometry. As a result of the lining up process, as shown in FIG. 7, the ribs are arranged displaced relative to one another in the longitudinal direction such that the pilot drilled and aligned bores 58, 64 now have clear bore displacements and in each case no longer form a common bore axis 60, 66 (cf. FIGS. 5 and 6).

The skin field 24, reinforced and lined up by means of the reinforcement structure 22, i.e. the lined up freight door 20, is mounted in a CNC-controlled shaft drilling and spindle facility—in what follows called a drilling device—in a vertical position in a reception device of the drilling device; it is mounted by means of its hook bores 54 in a stress-free manner such that it can pivot about a pivot axis, wherein its centre of gravity is arranged above the pivot axis. Here the pivot axis is simulating the pin axis of the hooks 44 (cf. FIG. 4). The freight door 20 is then pivoted into its installed orientation, or into a position close to its installed orientation, which corresponds to its locked position in the fuselage opening. In this position the freight door 20 is precisely oriented aerodynamically, and deformations occurring, for example, as a result of its own weight are taken into account as the method proceeds. In other words, in the simulated installed orientation the freight door 20 is essentially subjected to the loads that occur in the installed and closed state. By this means the loads are already taken into account during the formation of the kinematic system and the bores 58, 64 can be adjusted accordingly.

The door-side hinge elements 38 are then, as shown in FIG. 7, attached in the region of the upper edge 32 to the skin field 24. The hinge elements 38 have already been positioned in advance in a fixture device of the drilling device in accordance with their design positions. By this means the spacing between the course of the hinge axis 34 in the drilling device, and the freight door 20 in its installed orientation, is simulated, and the hinge elements 38 on this hinge axis 34 are oriented relative to one another on an inner surface 70 of the freight door 20. Tolerances between the skin field 24 and the hinge elements 38 are compensated for by means of appropriate material strips, washers, spacers and similar. A CNC-controlled drilling head is then positioned opposite to an outer surface of the skin field 24 facing away from the observer and attachment holes are introduced into the skin field 24, and also into the respective hinge element 38, for purposes of attaching the hinge elements. The drilling head can be embodied as a multifunctional machining head, which also enables riveting. In principle it can be deployed at any location of the skin field 24, i.e. of the outer surface.

The attachment of the hinge elements 38 to the skin field 24 is preferably undertaken by means of rivets, whose heads are sunk in appropriate funnel-shaped countersinks in the skin field, such that an aerodynamically favourable outer surface is created. The countersinks are formed during the drilling process, wherein the drilling head is equipped with an appropriate measurement device for measuring a respective countersink depth. The measurement device preferably has a sensor system, which measures a current rise of a spindle drive of the drilling head and halts the drilling procedure as soon as the required countersink depth is achieved. However, the countersink depth can also be determined by means of structure-borne sound. After the drilling of the attachment holes these are cleaned appropriately, and the hinge elements 38 are connected by means of attachment means such as rivets to the skin field 24.

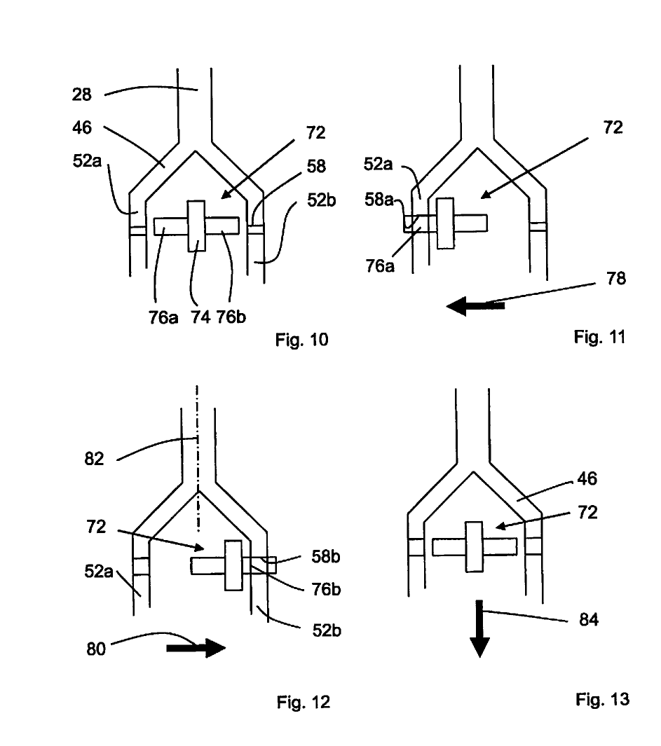

At the same time as the orientation and connection of the hinge elements 38 is taking place, each of the bores 58, 64 is finish-drilled to a final dimension (cf. FIGS. 10 to 13) by means of a further CNC-controlled drilling head 72. Here the pilot diameter has been selected such that, as shown in FIG. 8, after the finish-drilling the holes 58, 64 are once again oriented in alignment, in each case with a common bore axis 60, 66. In particular the final dimension of the bores 58, 64 is selected such that, as shown in FIG. 9, the drive shaft 48 and the security shaft 50 can be mounted by means of bushings 62 in the bores 58, 64 respectively. As shown in FIG. 10, the bushings 62 are preferably positioned on the shafts 48, 64 in accordance with the rib spacing, and are then introduced together with the latter as a unit into the bores 58. After the formation of bores 58, 64 that are aligned with one another, and the fitting of the hinge elements 38, the inventive machining of the freight door 20 in the drilling device is complete. The kinematic system 48, 50 can be installed, and the freight door 20 can be enclosed by the connection of an inner-side skin field 26 (cf. FIG. 4).

In accordance with FIG. 10 the drilling head 72 has at least one drive unit 74 for the finish-drilling of the bores 58 with two diametrically arranged clamping elements for purposes of clamping one drill 76a, 76b in each case. The drills 76a, 76b are of identical design, but can also be embodied with cutters of opposite orientation. For purposes of reversing the direction of rotation the drilling head 72 has an appropriate direction of rotation reversal unit, not shown.

For purposes of finish-drilling the drilling head 72 is arranged in a starting position between the arms 52a, 52b of the respective rib fork 46. The drive unit 74 is then activated and the drills 76a, 76b are set into rotation. Now, as shown in FIG. 11, the drilling head 72 is moved out of its starting position in the direction of the left-hand arm 52a, in accordance with the arrow 78, and the bore 58a in this arm 52a is finish-drilled to its final dimension with the left-hand drill 76a.

After the bore 58a in the left-hand arm 52a has been finish-drilled, the bore 58b in the right-hand arm 52b is finish-drilled to its final dimension. This is undertaken, as shown in FIG. 12, by means of a traverse movement of the drilling head 72 in the opposite direction, in accordance with the arrow 80, through its starting position, and towards the right-hand arm 52b. As soon as the drilling head 72 has passed through the longitudinal axis 78 of the rib 8, the direction of rotation of the drills 76a, 76b is reversed. The drills 76a, 76b are now rotating in the opposite direction and the bore 58b in the second arm 52 is drilled out to its final dimension by means of the right-hand drill 76b. Needless to say, the bore 58b in the right-hand arm 52b can be the first to be finish-drilled, and the bore 58a in the left-hand arm 52a can be finish-drilled to its final dimension subsequently. After the finish-drilling of the bore 58b the drilling head is moved back into its starting position, and, as indicated in an exemplary manner by arrow 84, is removed from the rib fork 46. The drilling head 72 is then positioned in an adjacent rib fork 46 and the bores 58a, 58b in that rib fork are formed accordingly.

The finish-drilling of the bores 64 for the security shaft can be undertaken by the same drilling head 72. The drilling device can, however, also make use of at least one second CNC-drilling head with diametrically arranged cutting tools.

Disclosed is a drilling device with a reception device for purposes of receiving a component 20, in particular a freight door, with at least one drilling head 72 for purposes of introducing at least one bore 58 into the component 20, wherein the reception device allows stress-free mounting of the component 20 in its installed orientation.

What is claimed is:

1. A drilling device, comprising:
a reception device for receiving a component; and
at least one drilling head for introducing at least one bore into the component, wherein the reception device allows stress-free mounting of the component in its installed orientation.

2. The drilling device in accordance with claim 1, wherein the reception device defines a pivot axis for pivoting the component.

3. The drilling device in accordance with claim 2, wherein the component is essentially positioned vertically, and the pivot axis runs underneath a centre of gravity of the received component.

4. The drilling device in accordance with claim 1, wherein the drilling head has two diametrically arranged clamping elements for receiving a cutting tool in each case.

5. The drilling device in accordance with claim 4, wherein the drilling head has a direction of rotation reversal unit.

6. The drilling device in accordance with claim 1, wherein a second machining head is provided, which can be activated independently of the drilling head.

7. The drilling device in accordance with claim 6, wherein the machining head is a second drilling head for receiving a cutting tool.

8. The drilling device in accordance with claim 7, wherein a measurement device is provided for determining a machining depth of at least the second drilling head.

9. The drilling device in accordance with claim 8, wherein the measurement device has a sensor system for measuring a current rise of a spindle drive receiving the cutting tool.

10. The drilling device in accordance with claim 8, wherein the measurement device has a sensor system for measuring the machining depth by means of structure-borne sound.

11. The drilling device in accordance with claim 1, wherein a fixture device is provided for the positioning of parts to be attached to the component.

12. The drilling device in accordance with claim 1, wherein the component comprises a freight door of an aerospace vehicle.
